(19) United States
(12) Patent Application Publication
(10) Pub. No.: US 2024/0362414 A1
(43) Pub. Date: Oct. 31, 2024

(54) METHOD AND SYSTEM FOR ELECTRONIC DECOMPOSITION OF DATA STRING INTO STRUCTURALLY MEANINGFUL PARTS

(71) Applicant: Innoplexus AG, Eschborn (DE)

(72) Inventor: Nils Bertschinger, Frankfurt am Main (DE)

(73) Assignee: Innoplexus AG, Eschborn (DE)

(21) Appl. No.: 18/308,701

(22) Filed: Apr. 28, 2023

(51) Int. Cl. G06F 40/284; G06F 40/211; G06N 7/01

(52) U.S. Cl. CPC G06F 40/284; G06F 40/211; G06N 7/01

(57) ABSTRACT

A method for electronic decomposition of a data string into structurally meaningful parts. The method includes receiving the data string as an input data and splitting the data string into a plurality of tokens. The method further includes performing an inter token modelling on the plurality of tokens to obtain a first probability of arrangement of tokens with respect to each other and performing an intra token modelling on the plurality of tokens to obtain a second probability indicative of a number of occurrences of each individual token. The method further includes combining the first probability of arrangement of tokens, with the second probability to obtain a final probability of an arrangement for the data string and displaying one or more arrangements for the data string based on the final probability. The method is advantageous to remove ambiguity while determining structurally meaningful parts of the data string.

### FIELD OF TECHNOLOGY

The present disclosure relates generally to natural language processing, and more specifically, to a method and a system for electronic decomposition of data string into structurally meaningful parts.

### BACKGROUND

In natural language processing (NLP), semantic analysis is used by machines to analyze structure and context of a natural language text. In the case of the natural language text in a form of data, such as person names or date timestamps, there are several different formats possible in which the person names or date timestamps can be written. The format of the person names and date timestamps is dependent on practices followed in different geographical areas or cultures. For example, in western countries, first or given names are commonly written before family names or last names. In some countries, a family name or last name is written before the first name separated by a comma. Similarly for dates, different formats, such as dd/mm/yyyy or mm/dd/yyyy or yyyy/dd/mm (dd represents a date, mm represents a month. and yyyy represents year) are possible and for timestamps, HH:MM:SS, SS:HH:MM, HH:SS:MM (HH represents hour, MM represents minutes and SS represents seconds) and the like are possible. Due to multiple possible formats, there is a difficulty in determining meaningful parts of the person names or date timestamps by the machines during the semantic analysis (i.e., which is first name, which is last name, which is a date, and the like.).

Conventionally, the problem of determining meaningful parts of person names and date timestamps by the machines involves rule-based approaches. For example, for person names, machines commonly combine simple rules with extensive dictionaries of valid first names, family names, titles, and the like. Similarly, for date timestamps, machines use regular expressions or similar formalisms to describe possible formats of date timestamps. However, the existing rule-based approach has limitations in case of ambiguity in the data string due to different possible formats. In other words, the existing rule-based approach is not able to eliminate invalid structural formats, which is not beneficial and may cause an inaccurate interpretation of the data strings by a user. Thus, there exists a need to remove ambiguity in determining meaningful parts of the data string in which different structural formats are possible.

Further limitations and disadvantages of conventional and traditional approaches will become apparent to one of skill in the art through comparison of such systems with some aspects of the present disclosure, as set forth in the remainder of the present application with reference to the drawings.

### BRIEF SUMMARY OF THE DISCLOSURE

The present disclosure provides a method and system for the electronic decomposition of a data string into structurally meaningful parts. The present disclosure seeks to provide a solution to the existing problem of how to remove ambiguity in determining meaningful parts of the data string in which different structural formats are possible. An aim of the present disclosure is to provide a solution that overcomes at least partially the problems encountered in the prior art and provide an improved method and an improved system for the electronic decomposition of the data string into structurally meaningful parts.

In one aspect, the present disclosure provides a method for electronic decomposition of a data string into structurally meaningful parts, the method comprises:
receiving, by a controller, the data string as an input data;
splitting, by the controller, the data string into a plurality of tokens;
performing, by the controller, an inter token modelling on the plurality of tokens to obtain a first probability of arrangement of tokens with respect to each other, wherein the first probability is indicative of one or more structural forms of the plurality of tokens;
performing, by the controller, an intra token modelling on the plurality of tokens to obtain a second probability indicative of a number of occurrences of each individual token in the arrangement of tokens of the plurality of tokens,
combining, by the controller, the first probability of arrangement of tokens with respect to each other, with the second probability to obtain a final probability of an arrangement for the data string; and
displaying, by the controller, one or more arrangements for the data string based on the final probability, wherein the one or more arrangements for the data string is indicative of the structurally meaningful parts of decomposed data string.

The method is used for determining the final probabilities of each possible arrangement for the data string, which is beneficial to remove ambiguity in determining meaningful parts of the data string by allowing few valid and possible arrangements for the data string. Furthermore, the method includes, performing separate inter-token modelling and intra token modelling of the data string, which is beneficial to allow known structural relations, that is by restricting the arrangements for the data string to a few possible arrangements (or covering all allowed variations in the arrangements for the data string). The method is used to retain flexibility in modelling statistics of each individual token from the plurality of tokens.

In addition, the method combines the inter token modelling and the intra token modelling into a single probabilistic model (i.e., the probabilistic context-free grammar (PCFG) model), which is beneficial to allow end-to-end training of the PCFG model and exploiting the structural relationships between the plurality of tokens as well as statistical properties within each individual token from the plurality of tokens. Along with person names, the method is also applicable to decompose and disambiguate data strings representing a date or contact information, that is, where some information on possible structural formats is known, yet ambiguous formatting conventions are allowed.

In another aspect, the present disclosure provides a system for decomposition of a data string, the system comprising:
a memory configured to store the data string;
a controller configured to:
   receive the data string as input data;
   split the data string into a plurality of tokens;
   perform an inter token modelling on plurality of tokens to obtain a first probability of arrangement of tokens with respect to each other, wherein the first probability is indicative of one or more structural forms of the plurality of tokens;
   perform an intra token modelling on the plurality of tokens to obtain a second probability indicative of a number of occurrences of each individual token at in the arrangement of tokens of the plurality of tokens,
   combine the first probability of the arrangement of tokens with the second probability of each token from of the plurality of tokens to obtain a final probability of arrangement for the data string; and
   display one or more arrangements for the data string based on the final probability, wherein the one or more arrangements for the data string is indicative of structurally meaningful parts of decomposed data string.

The system achieves all the advantages and technical effects of the method of the present disclosure.

It has to be noted that all devices, elements, circuitry, units and means described in the present application could be implemented in the software or hardware elements or any kind of combination thereof. All steps which are performed by the various entities described in the present application as well as the functionalities described to be performed by the various entities are intended to mean that the respective entity is adapted to or configured to perform the respective steps and functionalities. Even if, in the following description of specific embodiments, a specific functionality or step to be performed by external entities is not reflected in the description of a specific detailed element of that entity which performs that specific step or functionality, it should be clear for a skilled person that these methods and functionalities can be implemented in respective software or hardware elements, or any kind of combination thereof. It will be appreciated that features of the present disclosure are susceptible to being combined in various combinations without departing from the scope of the present disclosure as defined by the appended claims.

Additional aspects, advantages, features, and objects of the present disclosure would be made apparent from the drawings and the detailed description of the illustrative implementations construed in conjunction with the appended claims that follow.

### BRIEF DESCRIPTION OF THE DRAWINGS

The summary above, as well as the following detailed description of illustrative embodiments, is better understood when read in conjunction with the appended drawings. For the purpose of illustrating the present disclosure, exemplary constructions of the disclosure are shown in the drawings. However, the present disclosure is not limited to specific methods and instrumentalities disclosed herein. Moreover, those in the art will understand that the drawings are not to scale. Wherever possible, like elements have been indicated by identical numbers.

Embodiments of the present disclosure will now be described, by way of example only, with reference to the following diagrams wherein:

FIG. 1 is a block diagram of a system for electronic decomposition of a data string into structurally meaningful parts, in accordance with an embodiment of the present disclosure; and

FIG. 2 is a flowchart of a method for electronic decomposition of a data string into structurally meaningful parts, in accordance with an embodiment of the present disclosure.

In the accompanying drawings, an underlined number is employed to represent an item over which the underlined number is positioned or an item to which the underlined number is adjacent. A non-underlined number relates to an item identified by a line linking the non-underlined number to the item. When a number is non-underlined and accompanied by an associated arrow, the non-underlined number is used to identify a general item at which the arrow is pointing.

### DETAILED DESCRIPTION OF THE DISCLOSURE

The following detailed description illustrates embodiments of the present disclosure and ways in which they can be implemented. Although some modes of carrying out the present disclosure have been disclosed, those skilled in the art would recognize that other embodiments for carrying out or practicing the present disclosure are also possible.

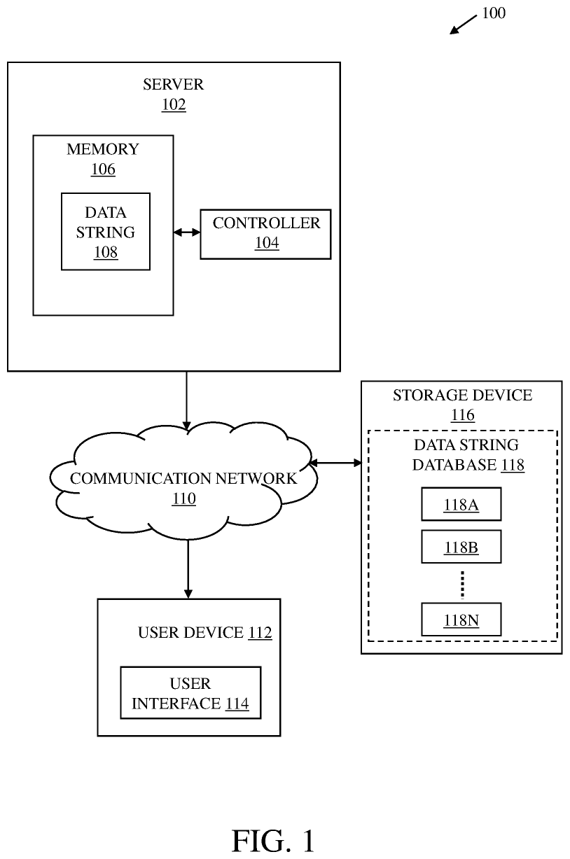

FIG. 1 is a block diagram that depicts a system for electronic decomposition of a data string into structurally meaningful parts, in accordance with an embodiment of the present disclosure. With reference to FIG. 1, there is shown a block diagram that depicts a system 100 for the electronic decomposition of a data string 108 into structurally meaningful parts. The system 100 includes a server 102, which further includes a controller 104, and a memory 106. The controller 104 is communicatively coupled with the memory 106. The system 100 may be used to process the data string 108.

In an implementation, the controller 104 and the memory 106 may be implemented on a same server, such as on the server 102. In some implementations, the system 100 further includes a storage device 116 communicatively coupled to the server 102 via a communication network 110. The storage device 116 includes a data string database 118 of one or more data strings 118A to 118N. In some implementations, the one or more data strings 118A to 118N may be retrieved from the storage device 116 by the memory 106, as per requirement. In some implementations, the data string database 118 may be stored in the same server, such as the server 102. In some other implementations, the data string database 118 may be stored outside the server 102, as shown in FIG. 1. Furthermore, the server 102 may be communicatively coupled to a plurality of user devices, such as a user device 112, via the communication network 110. In addition, the user device 112 includes a user interface 114.

The storage device 116 may be any storage device that stores data and applications without any limitation thereto. In an implementation, the storage device 116 may be a cloud storage, or an array of storage devices.

The server 102 includes suitable logic, circuitry, interfaces, and code that may be configured to communicate with the user device 112 via the communication network 110. In an implementation, the server 102 may be a master server or a master machine that is a part of a data center that controls an array of other cloud servers communicatively coupled to it for load balancing, running customized applications, and efficient data management. Examples of the server 102 may include but are not limited to a cloud server, an application server, a data server, or an electronic data processing device.

In an implementation, the controller 104 refers to a computational element that is operable to respond to and processes instructions that drive the system 100. The controller 104 may refer to one or more individual processors, processing devices, and various elements associated with a processing device that may be shared by other processing devices. Additionally, the one or more individual processors, processing devices, and elements are arranged in various architectures for responding to and processing the instructions that drive the system 100. Examples of the controller 104 may include but are not limited to, a hardware processor, a digital signal processor (DSP), a microprocessor, a microcontroller, a complex instruction set computing (CISC) processor, an application-specific integrated circuit (ASIC) processor, a reduced instruction set (RISC) processor, a very long instruction word (VLIW) processor, a state machine, a data processing unit, a graphics processing unit (GPU), and other processors or control circuitry.

The communication network 110 includes a medium (e.g., a communication channel) through which the user device 112 communicates with the server 102. The communication network 110 may be a wired or wireless communication network. Examples of the communication network 110 may include but are not limited to, the Internet, a Local Area Network (LAN), a wireless personal area network (WPAN), a Wireless Local Area Network (WLAN), a wireless wide area network (WWAN), a cloud network, a Long-Term Evolution (LTE) network, a plain old telephone service (POTS), a Metropolitan Area Network (MAN), and/or the Internet.

The system 100 includes the memory 106 configured to store the data string 108. The memory 106 refers to a volatile or persistent medium, such as an electrical circuit, magnetic disk, virtual memory, or optical disk, in which a computer can store data or software for any duration. Optionally, the memory 106 is a non-volatile mass storage, such as a physical storage media. Examples of implementation of the memory 106 may include but are not limited to, an Electrically Erasable Programmable Read-Only Memory (EEPROM), Dynamic Random-Access Memory (DRAM), Random Access Memory (RAM), Read-Only Memory (ROM), Hard Disk Drive (HDD), Flash memory, a Secure Digital (SD) card, Solid-State Drive (SSD), and/or CPU cache memory. In an implementation, the data string 108 is a sequence of words, which represents some textual data, such as a sentence, a paragraph, or an entire document. In another implementation, the data string 108 is a surface string. The surface string is a sequence of words, which represents a textual data without consideration of any underlying meaning or structure.

The user device 112 refers to an electronic computing device operated by a user, such as through the user device 112. In an implementation, the user device 112 may be configured to obtain a user input of the data string 108 in a user interface 114 that is rendered over the user device 112 and communicate the user input to the server 102. The server 102 may then be configured to retrieve the data string 108 from the user device 112. Examples of the user device 112 may include but are not limited to a mobile device, a smartphone, a desktop computer, a laptop computer, a Chromebook, a tablet computer, a robotic device, or other user devices.

In operation, the system 100 includes the controller 104 that is configured to receive the data string 108 as an input data. In an implementation, the data string 108 is a sequence of words, which represents some textual data, such as a sentence, a paragraph, or an entire document. In another implementation, the data string 108 is a surface string, that is a sequence of words, which represents a textual data without consideration of any underlying meaning or structure. In other words, the sequence of words in the surface string does not follow any grammatical rule or any meaningful order. In an example, the data string 108 as the input data is a person name, such as “Smith Harry” or a date timestamp, such as “1/10/2001 11:30:22”. In accordance with an embodiment, the controller 104 is configured to utilize the user interface 114 to receive the data string 108 from the user. In an example, the user interface 114 is an interface through which the user can interact with the controller 104. In another implementation, a document including multiple data strings is uploaded by the user into the controller 104 through the user interface 114. Examples of the user interface 114 may include but are not limited to screen display, keyboard, computer mouse, remote control, and the like.

The controller 104 is configured to split the data string 108 into a plurality of tokens. In an implementation, the plurality of tokens are the smallest individual units in which the data string 108 is divided by the controller 104. For example, the data string 108 is “Smith, Harry”. Here, the controller 104 is configured to split the data string 108 “Smith, Harry” into the plurality of tokens as <Smith>, <comma>, <Harry>. Here, <comma> is a special token, which represents the special literal character “,”. In accordance with an embodiment, the plurality of tokens are generated using a word tokenizer or a character tokenizer. In an implementation, the word tokenizer is a whitespace tokenizer, which tokenizes the data string 108 into tokens whenever the tokenizer encounters a whitespace character. For example, the data string 108 corresponds to “Smith Harry”, which includes a space between two words that is between “Smith” and “Harry”. Moreover, due to the space between two words, the data string 108 is tokenized, such as “Smith Harry” is tokenized into <Smith> and <Harry>. The application of the word tokenizer or the character tokenizer to split the data string 108 into the plurality of tokens is beneficial to simplify the process of assigning meaning to each token from the plurality of tokens of the data string 108. Thereafter, the controller 104 is configured to perform an inter token modelling on plurality of tokens to obtain a first probability of arrangement of tokens with respect to each other. Moreover, the first probability is indicative of one or more structural forms of the plurality of tokens. In an implementation, the inter token modelling refers to a process of analyzing and understanding the relationship between the plurality of tokens in the data string 108. In an implementation, the inter token modelling involves developing models that can predict a likelihood of the plurality of tokens appearing together in the data string 108.

In accordance with an embodiment, in order to perform the inter token modelling on plurality of tokens, the controller 104 is further configured to apply a probabilistic context free grammar (PCFG) model on plurality of tokens. In an implementation, the PCFG model is a type of context free grammar (CFG) where each production rule has an associated probability. Moreover, the production rule is a formal statement, which represents a formal grammatical rule that defines the syntax of a language. In an implementation, the PCFG is represented by a tuple (N, T, S, R, P), where N represents a set of non-terminal symbols or variables. T represents a set of terminal symbols or words, and S represents a start symbol or an initial non-terminal symbol. Further, R is a set of production rules, each of the form A1→B1 B2 . . . . Bn, A1→C1, C2 . . . . Cn, where A is a non-terminal symbol, B1, B2 . . . , Bn and C1, C2 . . . . Cn are either non-terminal or terminal symbols and P represents the probability of each production rule. The controller 104 performs the inter token modelling by applying the PCFG model to the plurality of tokens and to generate the one or more structural forms of the plurality of tokens.

In accordance with another embodiment, in order to perform the inter token modelling on the plurality of tokens, the controller 104 is configured to apply a pre-trained probabilistic context free grammar (PCFG) model on the plurality of tokens. In an implementation, the pre-trained PCFG model is trained through a corpus of text to identify syntactic structures of sentences. In another implementation, the pretrained PCFG model is trained on the corpus of text using different techniques, such as maximum likelihood estimation or Bayesian methods. The corpus of text refers to a collection of textual data.

In accordance with an embodiment, in order to perform the inter token modelling on the plurality of tokens, the controller 104 is further configured to parse the plurality of tokens to generate one or more structural forms. In an implementation, the controller 104 is configured to generate a derivation or a parse tree, which represents a definite arrangement of tokens. Moreover, the one or more structural forms are subparts of the derivation or parse tree. In an example, the controller 104 is configured to generate a parse tree, which represents the arrangement of tokens from the plurality of tokens as follows:

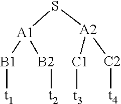

In such an example, S is the start symbol, A1, A2, B1, B2, C1, and C2 are non-terminal symbols and t1, t2, t3 and t4 are terminal symbols or tokens. Moreover, the production rules of the parse tree according to the PCFG are as follows—
S→A1 A2
A1→B1|B2
A2→C1|C2
B1→t1
B2→t2
C1→t3
C2→t4

In an implementation, each production rule represents one structural form of the plurality of tokens, that is, S→A1 A2 is one structural form of the data string 108. A1→B1|B2 is another structural form and on the like. In an implementation, the controller 104 generates the parse tree for one arrangement of tokens from the plurality of tokens. Similarly, for multiple possible arrangements of the plurality of tokens, multiple parse trees are generated. For example, the data string 108 corresponds to “Smith, Harry”, and the controller 104 splits the data string 108 into the plurality of tokens, such as <Smith>, <comma>, <Harry>. As a result, multiple arrangements of the plurality of tokens are possible. Therefore, the controller 104 is configured to generate multiple parse trees for the multiple arrangements of the plurality of tokens. Furthermore, the one or more structural forms are generated by the controller 104 based on the set of production rules of the pre-trained PCFG model.

In an implementation, the PCFG model in the controller 104 is trained with a training dataset that includes a data equivalent to the data string 108. For example, the data string 108 includes a person's name in the form of a first name and last name (with or without a comma). Here, the controller 104 is fed with the training dataset, which includes the collection of common person names (first name and last name with or without comma) and the controller 104 is configured to train based on the training dataset and identify the frequency of each production rule from the collection of person names. Furthermore, in order to perform the inter token modelling on the plurality of tokens, the controller 104 is further configured to obtain a probability of each structural form of the one or more structural forms. In an implementation, the training dataset represents a large number of possible structural forms of person names. The controller 104 determines the frequency of person names following a definite structural form and obtains the probability of the corresponding structural form. For example, the structural form represented by the production rule A1→B1|B2 is occurred 800 times out of 1000 person names provided in the training dataset. Therefore, the probability of the structural form A1→B1|B2 is 800/1000=0.8. Further, the controller 104 is configured to determine the first probability of the arrangement of tokens by combining probabilities of each structural form from the one or more structural forms. In an implementation, the controller 104 is configured to determine the probability of each structural form from the one or more structural forms and based on the frequency of each structural form in the training dataset. For example, the controller 104 is configured to calculate the probability, such as P (S1→A1 A2) (i.e., probability of structural form S1→A1 A2), P (A1→B1|B2), P (A2→C1C2), P (B1→t1), P (B2→t2), P (C1→t3), and P (C2→t4). Thereafter, the controller 104 is configured to combine the probabilities of each structural form to obtain the first probability of the arrangement of tokens from the plurality of tokens. In an implementation, the first probability of the arrangement of tokens from the plurality of tokens indicates the possibility of the corresponding arrangement of tokens to form a meaningful person name. In an example, if the first probability of any arrangement of tokens is zero, then such arrangement of tokens is not possible and such arrangement of tokens does not form a valid person name.

In an implementation, the PCFG defines a probability distribution over arrangements of tokens and efficient algorithms exist for computing the probability of a particular arrangement of tokens. Moreover, due to un-supervised learning of the PCFG model, the detailed information on the probabilities of the one or more structural forms is not required, but readily learned from unlabelled data in the training dataset. In accordance with an embodiment, the data string 108 is an unlabelled data string for un-supervised learning. In an implementation, the PCFG model is trained with the training dataset thorough un-supervised learning, with combination of labelled and unlabelled data. For example, a definite number of person names in the training data set are labelled as “First name Last Name”, or “Last Name First Name”, or “Last Name, First Name”, whereas the remaining person names are not labelled. After training the PCFG model, the data string is entered as the unlabelled data. Furthermore, the un-supervised learning of the PCFG model is advantageous to provide accuracy in determining the first probability of the arrangement of tokens and requires less processing time for training.

Furthermore, the controller 104 is configured to perform an intra token modelling on the plurality of tokens to obtain a second probability indicative of a number of occurrences of each individual token in the arrangement of tokens of the plurality of tokens. In an implementation, the controller 104 is configured to obtain the second probability of each individual token from the training dataset fed to the controller 104, such as during the process of training. For example, the training data set includes multiple common person names and the controller 104 is configured to determine the frequency of each individual token in the training dataset. In such an example, 2500 examples of common person names are included in the training dataset. The exemplary table (Table 1) of a number of occurrences of each token in the data string 108 “Smith Harry” from the 2500 examples is as follows:

TABLE 1

| Token | Frequency |
|---|---|
| Smith | 1000 |
| Harry | 1500 |

Here, the second probability of the token <Smith> is calculated as:

$$P ( Smith ) = The number of occurrences of the token \\ \\ \\ “ Smith ” as the last name / total last names = 1000 / 2500 = 0.4$$

Similarly, the second probability of the token <Harry> is calculated as:

$$P ( Stefanie ) = The number of occurrences of the token \\ \\ \\ “ Harry ” as first name / total first names = 1500 / 2500 = 0.6 .$$

In such example, the second probability of the token “Smith” indicates that there is 40% probability of the token “Harry” to appear as the last name and the second probability of the token “Stefanie” indicates that there is 60% probability of the token “Stefanie” to appear as the first name.

In accordance with an embodiment, the controller 104 is further configured to apply an N-gram model or unigram probabilities to obtain the second probability indicative of a number of occurrences of each individual token. In other words, the controller 104 applies the N-gram model or unigram probabilities on the training dataset to determine the second probability of each individual token. In an implementation, the N-gram model a statistical language model that predicts the probability of a sequence of N tokens based on the number of occurrences of corresponding N tokens in the training dataset. The unigram probabilities refer to the probability of each individual token in the training dataset. In other words, the unigram probabilities refer to the N gram model with a value of N=1. In such implementation, the controller 104 determines the second probability of each individual token based on the training dataset by using the N-gram model. In an implementation, the plurality of tokens are obtained from the data string 108 through byte pair encoding. The byte pair encoding is a compression algorithm, which is used to create the plurality of tokens from the data string 108 by replacing the most frequently occurring pair of characters in the data string with a character that is not present in the data string 108.

In accordance with an embodiment, the controller 104 is further configured to use machine learning models to obtain the first probability of the arrangement of tokens with respect to each other and the second probability indicative of a number of occurrences of each individual token in the arrangement of tokens of the plurality of tokens. In an implementation, the machine learning models used by the controller 104 are trained on un-supervised learning methods through the training dataset. In an implementation, the machine learning models are trained by maximum likelihood on unlabelled training datasets while exploiting known structural constraints. The maximum likelihood is a statistical method that involves estimating the parameters of a machine learning model by finding the values that maximize the likelihood of observing a definite data.

Furthermore, the controller 104 is configured to combine the first probability of the arrangement of tokens with the second probability of each individual token from of the plurality of tokens to obtain a final probability of arrangement for the data string 108. In an implementation, the arrangement for the data string 108 is an arrangement of the tokens in the data string 108. For example, “Smith, Harry” is one arrangement for the data string 108, “Harry, Smith” is another arrangement for the data string 108 and the like.

In an implementation, the first probability of each arrangement of tokens with respect to each other and the second probability of each individual token are combined together to obtain the final probability by using following formula:

$$P ( s ) = {P}_{P C F G} ( {t}_{1} … {t}_{n} ) \times {\prod }_{i = 1}^{m} {P}_{LM} ( {t}_{i} )$$

Where P(s)=final probability of an arrangement for data string 108, P_{PCFG}=The first probability of an arrangement of tokens and P_{LM}=the second probability of each individual token.

In an implementation, the controller 104 is configured to generate the more than one possible arrangement for the data string 108. For each arrangement of the data string 108, the controller 104 determines the final probability of the corresponding arrangement of the data string 108. The final probability of the arrangement for the data string 108 indicates the extent of possibility of the corresponding arrangement for the data string 108 to be recognized as a valid person name. For example, the arrangement for the “Harry, Smith” is having a zero probability as “Harry” is not occurred as the last name in any person name included in the training dataset. In other words, the extent of the possibility of the arrangement for the data string 108 such as “Harry, Smith” to be recognized as the valid person name is zero, that is, “Harry, Smith” does not form a valid person name.

The controller 104 is further configured to display one or more arrangements for the data string 108 based on the final probability, such as the one or more arrangements for the data string 108 are indicative of structurally meaningful parts of decomposed data string. In other words, the controller 104 is configured to display the one or more arrangements for the data string 108 along with the final probability of corresponding arrangement for the data string 108. For example, “Smith, Harry” is one arrangement for the data string 108 with a final probability 0.8, “Harry Smith” is another arrangement for the data string 108 with a final probability 0.7, and “Harry, Smith” is one arrangement for the data string 108 with the final probability 0. In accordance with an embodiment, the controller 104 is further configured to display the one or more arrangements for the data string 108 on the user interface 114 based on a ranking of the final probability. In continuation with the previous example, the arrangement for the data string 108, such as “Smith, Harry” is having the highest final probability (i.e., the highest likelihood of forming a valid person name) is showed first and other arrangements for the data string 108 are displayed in descending order on the user interface 114. Here, the arrangements for the data string 108, such as “Smith, Harry” and “Harry Smith” are structurally meaningful parts of the decomposed data string (i.e., form valid person names), whereas the arrangement for the “Harry, Smith” does not form the structurally meaningful part. In an implementation, the controller 104 is configured to disambiguate multiple possible arrangements for the data string 108 by selecting the most probable arrangement for the data string 108.

The operation of the system 100 is explained with an example of the data string 108, such as “Smith, Harry”. The controller 104 receives the data string 108 “Smith, Harry” through the user interface 114. Further, the controller 104 is configured to split the “Smith, Harry” into the plurality of tokens, such as <Smith> <comma> <Harry>. Furthermore, the controller 104 is configured to perform the inter token modelling of the plurality of tokens by parsing the plurality of tokens to generate a parse tree, which includes one or more structural forms. An example of the structural forms in the parse tree is as follows:

### S→First Last|Last First|LastComma First

### LastComma→Last Comma

### First→first_name_token

### Last→last_name_token

### Comma→<comma>

Further, during the inter token modelling, the controller 104 is configured to determine the probability of each structural form through the PCFG model, such as P (S→First Last|LastFirst|LastComma First), P(LastComma→Last Comma), P(First→first_name_token), P(First→first_name_token) and P(Comma→<comma>). Further, during the intra token modelling, the controller 104 is configured to determine the second probability of each individual token, such as P (Smith), P (comma), and P (Harry). Further, in order to obtain the final probability, the controller 104 is configured to combine the first probability obtained through the inter token modelling (e.g., using the PCFG model) and the second probability obtained through intra token modelling (e.g., using the N-gram model) to obtain the final probability of the arrangement for the data string 108. After determining the final probability, the controller 104 is configured to display the one or more arrangements for the data string 108 according to the final probability. In other words, the controller 104 is configured to display the one or more arrangements that are labelled as last name or first name. In an example, in practice, the final probability is calculated of a surface string as P(S), which means that the output is presented as most probable and least probable surface string arrangement and a given user can select as per choice or needs based on multiple options of arrangements, for example, as follows:
Smith, Harry=0.8 (Most probable)
Harry Smith=0.7 (Probable)
Smith Harry=0.7 (Probable)
Harry, Smith=0 (Impossible)
   From above-mentioned multiple options of arrangements with most probable and least probable surface string arrangement displayed on the user interface, the user may conclude that the arrangement for the data string, for example, in this case, “Harry, Smith” is not possible and the user is less likely to get confused to interpret “Harry” as the last name. Therefore, such restriction is enough to learn that “Harry” is most likely the first name when the training dataset contains enough examples following an unambiguous format “Last <comma>First”. It is to be understood that the calculation of final probability with multiple options of arrangements with most probable and least probable surface string arrangement is explained by taking an example of names. However, it is to be understood that this may apply to dates, timestamps, or any other surface strings of text may be manipulated as per use case without limiting the scope of the disclosure.

The system 100 uses the probabilistic context free grammar (PCFG) to determine the final probabilities of each possible arrangement for the data string 108, which is beneficial to remove ambiguity in determining meaningful parts of the data string 108 (in which different structural formats are possible) by allowing few valid and possible arrangements for the data string 108. The controller 104 of the system 100 is configured to perform separate inter-token modelling and intra token modelling of the data string 108, which is beneficial to allow known structural relations, that is, restricting the PCFG to a few possible arrangements for the data string 108 (or covering all allowed variations in the arrangements for the data string 108). The system 100 is beneficial to retain flexibility in modelling statistics of each individual tokens from the plurality of tokens.

In addition, the controller 104 of the system 100 is configured to combine the inter token modelling and the intra token modelling into a single probabilistic model (i.e., the PCFG model), which is beneficial to allow end-to-end training of the PCFG model and exploiting the structural relationships between the plurality of tokens as well as statistical properties within each individual token from the plurality of tokens. Along with person names, the system 100 is also applicable to decompose and disambiguate data strings representing date or contact information, that is, where some information on possible structural formats is known, yet ambiguous formatting conventions are allowed.

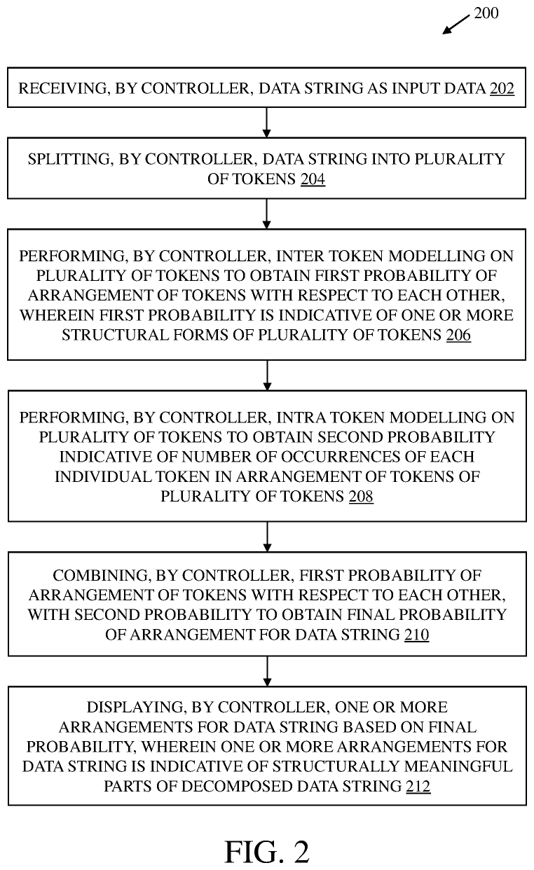

FIG. 2 is a flowchart of a method for electronic decomposition of a data string into structurally meaningful parts, in accordance with an embodiment of the present disclosure. FIG. 2 is described in conjunction with elements of FIG. 1. With reference FIG. 2, there is shown a flowchart of a method 200 for electronic decomposition of the data string 108 into structurally meaningful parts. The method 200 includes steps 202 to 212.

At step 202, the method 200 includes receiving, by the controller 104, the data string 108 as an input data. In an implementation, the data string 108 is a sequence of words, which represents some textual data, such as a sentence, a paragraph, or an entire document. In another implementation, the data string 108 is a surface string. In accordance with an embodiment, the method 200 includes utilizing, by the controller 104, the user interface 114 for receiving the data string 108 from a user. In an example, the user interface 114 is an interface through which the user can interact with the controller 104. In another implementation, a document including multiple data strings is uploaded by the user into the controller 104 through the user interface 114.

At step 204, the method 200 further includes splitting, by the controller 104, the data string 108 into a plurality of tokens. In an implementation, the plurality of tokens are the smallest individual units in which the data string 108 is divided by the controller 104. In accordance with an embodiment, the plurality of tokens are generated using a word tokenizer or a character tokenizer. In an implementation, the word tokenizer is a whitespace tokenizer. The whitespace tokenizer is a tokenizer, which tokenizes the data string 108 into tokens whenever the tokenizer encounters a whitespace character.

At step 206, the method 200 further includes performing, by the controller 104, an inter token modelling on the plurality of tokens to obtain a first probability of arrangement of tokens with respect to each other. Moreover, the first probability is indicative of one or more structural forms of the plurality of tokens. In an implementation, the inter token modelling refers to a process of analyzing and understanding the relationship between the plurality of tokens in the data string 108. In accordance with an embodiment, performing the inter token modelling on the plurality of tokens includes applying a probabilistic context free grammar (PCFG) model on the plurality of tokens by the controller 104. In accordance with another embodiment, performing the inter token modelling on the plurality of tokens includes applying a pre-trained probabilistic context free grammar (PCFG) model on the plurality of tokens by the controller 104. In an implementation, the PCFG model is a type of context free grammar (CFG) where each production rule has an associated probability. The controller 104 is configured to perform the inter token modelling by applying the PCFG model to the plurality of tokens and generating the one or more structural forms of the plurality of tokens.

In accordance with an embodiment, the performing the inter token modelling on the plurality of tokens includes parsing, by the controller 104, the plurality of tokens for generating one or more structural forms. In an implementation, the controller 104 is configured to generate a derivation or a parse tree, which represents a definite arrangement of tokens. The one or more structural forms are subparts of the derivation or parse tree. There are multiple arrangements of the plurality of tokens are possible. Therefore, the controller 104 is configured to generate multiple parse trees for the multiple arrangements of the plurality of tokens. The one or more structural forms are generated by the controller 104 based on the set of production rules of the pre-trained PCFG model. In such embodiment, performing the inter token modelling on the plurality of tokens further includes obtaining, by the controller, a probability of each structural form of the one or more structural forms. In an implementation, the PCFG model in the controller 104 is configured with a machine learning model, which is trained with a training dataset. The training dataset includes a data equivalent to the data string 108. Further, in accordance with a such embodiment, performing the inter token modelling on the plurality of tokens further includes determining, by the controller 104, the first probability of the arrangement of tokens by combining probabilities of each structural form from the one or more structural forms. In an implementation, the controller 104 is configured to determine probability of each structural form from the one or more structural forms based on the frequency of each structural form in the training dataset. Due to un-supervised learning of the PCFG model, the detailed information on the probabilities of the one or more structural forms is not required but readily learned from unlabelled data in the training dataset.

In accordance with an embodiment, the data string 108 is an unlabelled data string for un-supervised learning. In an implementation, the PCFG model is trained with the training dataset through semi-supervised learning, with unlabelled data. The semi-supervised learning of the PCFG model is advantageous to provide accuracy in determining the first probability of the arrangement of tokens and requires less processing time for training.

At step 208, the method 200 further includes performing, by the controller 104, an intra token modelling on the plurality of tokens to obtain a second probability indicative of a number of occurrences of each individual token in the arrangement of tokens from the plurality of tokens. In an implementation, the controller 104 is configured to obtain the second probability of each individual token from the training dataset fed to the controller 104 during training. In accordance with an embodiment, performing the intra token modelling over the plurality of tokens includes applying an N-gram model or unigram probabilities for obtaining the second probability indicative of a number of occurrences of each individual token. In other words, the controller 104 is configured to apply the N-gram model or unigram probabilities on the training dataset to determine the second probability of each individual token.

At step 210, the method 200 further includes, combining, by the controller 104, the first probability of arrangement of tokens with respect to each other, with the second probability of each individual token to obtain a final probability of arrangement for the data string 108. In an implementation, the arrangement for the data string 108 is an arrangement of tokens in the data string 108. In an implementation, the first probability of each arrangement of tokens with respect to each other and the second probability of each individual token are combined together to obtain the final probability by using following equation:

$$P ( s ) = {P}_{P C F G} ( {t}_{1} … {t}_{n} ) \times {\prod }_{i = 1}^{m} {P}_{LM} ( {t}_{i} )$$

Where P(s)=final probability of an arrangement for data string 108, P_{PCFG}=First probability of an arrangement of tokens and P_{LM}=Second probability of each individual token. In accordance with an embodiment, the method 200 further includes using machine learning models, by the controller 104, for obtaining the first probability of arrangement of tokens with respect to each other and the second probability indicative of the number of occurrences of each individual token in the arrangement of tokens of the plurality of tokens. In an implementation, the machine learning models used by the controller 104 are trained on un-supervised learning method through the training dataset.

At step 212, the method 200 includes displaying, by the controller 104, one or more arrangements for the data string 108 based on the final probability. In other words, the method 200 includes displaying, by the controller 104, the one or more arrangements that are labelled as last name or first name. Moreover, the one or more arrangements for the data string 108 is indicative of the structurally meaningful parts of decomposed data string. In other words, the controller 104 is configured to display the one or more arrangements for the data string 108 along with the final probability of corresponding arrangement for the data string 108. In accordance with an embodiment, the method 200 further includes displaying the one or more arrangements for data string 108 on the user interface 114 based on a ranking of the final probability. In an implementation, the arrangement for the data string 108 having highest final probability (i.e., highest likelihood of forming a valid person name) is showed first and other arrangements for the data string 108 are displayed in descending order on the user interface 114. In an implementation, the controller 104 is configured to disambiguate multiple possible arrangements for the data string 108 by choosing the most probable arrangement for the data string 108.

The method 200 uses the probabilistic context free grammar (PCFG) to determine the final probabilities of each possible arrangement for the data string 108, which is beneficial to remove ambiguity in determining meaningful parts of the data string 108 by allowing few valid and possible arrangements for the data string 108. The method 200 includes, performing separate inter-token modelling and intra token modelling of the data string 108, which is beneficial to allow known structural relations, by restricting the PCFG to a few possible arrangements for the data string 108 (or covering all allowed variations in the arrangements for the data string 108). The method 200 is used to retain flexibility in modelling statistics of each individual tokens from the plurality of tokens.

In addition, the method 200 is used to combine the inter token modelling and the intra token modelling into a single probabilistic model (i.e., the PCFG model), which is beneficial to allow end-to-end training of the PCFG model and exploiting the structural relationships between the plurality of tokens as well as statistical properties within each individual token from the plurality of tokens. Along with person names, the method 200 is also applicable to decompose and disambiguate data strings representing date or contact information, that is, where some information on possible structural formats is known, yet ambiguous formatting conventions are allowed.

Modifications to embodiments of the present disclosure described in the foregoing are possible without departing from the scope of the present disclosure as defined by the accompanying claims. Expressions such as “including”, “comprising”, “incorporating”, “have”, “is” used to describe and claim the present disclosure are intended to be construed in a non-exclusive manner, namely allowing for items, components or elements not explicitly described also to be present. Reference to the singular is also to be construed to relate to the plural. The word “exemplary” is used herein to mean “serving as an example, instance or illustration”. Any embodiment described as “exemplary” is not necessarily to be construed as preferred or advantageous over other embodiments and/or to exclude the incorporation of features from other embodiments. The word “optionally” is used herein to mean “is provided in some embodiments and not provided in other embodiments”. It is appreciated that certain features of the present disclosure, which are, for clarity, described in the context of separate embodiments, may also be provided in combination in a single embodiment. Conversely, various features of the present disclosure, which are, for brevity, described in the context of a single embodiment, may also be provided separately or in any suitable combination or as suitable in any other described embodiment of the disclosure.

What is claimed is:

1. A method for electronic decomposition of a data string into structurally meaningful parts, the method comprises:
receiving, by a controller, the data string as an input data;
splitting, by the controller, the data string into a plurality of tokens;
performing, by the controller, an inter token modelling on the plurality of tokens to obtain a first probability of arrangement of tokens with respect to each other, wherein the first probability is indicative of one or more structural forms of the plurality of tokens;
performing, by the controller, an intra token modelling on the plurality of tokens to obtain a second probability indicative of a number of occurrences of each individual token in the arrangement of tokens of the plurality of tokens,
combining, by the controller, the first probability of arrangement of tokens with respect to each other, with the second probability to obtain a final probability of an arrangement for the data string; and
displaying, by the controller, one or more arrangements for the data string based on the final probability, wherein the one or more arrangements for the data string is indicative of the structurally meaningful parts of decomposed data string.

2. The method according to claim 1, wherein performing the inter token modelling on the plurality of tokens comprises applying a probabilistic context free grammar (PCFG) model on the plurality of tokens.

3. The method according to claim 1, wherein performing the inter token modelling on the plurality of tokens comprises applying a pre-trained probabilistic context free grammar (PCFG) model on the plurality of tokens.

4. The method according to claim 1, performing the inter token modelling on the plurality of tokens comprises:
parsing, by the controller, the plurality of tokens for generating one or more structural forms,
obtaining, by the controller, a probability of each structural form of the one or more structural forms, and
determining, by the controller, the first probability of the arrangement of tokens by combining probabilities of each structural form from the one or more structural forms.

5. The method according to claim 1, wherein performing the intra token modelling over the plurality of tokens comprises applying an N-gram model or unigram probabilities for obtaining the second probability indicative of a number of occurrences of each individual token.

6. The method according to claim 1, wherein the data string is an unlabelled data string for un-supervised learning.

7. The method according to claim 1, further comprising, using machine learning models, by the controller, for obtaining the first probability of arrangement of tokens with respect to each other and the second probability indicative of the number of occurrences of each individual token in the arrangement of tokens.

8. The method according to claim 1, wherein the plurality of tokens are generated using a word tokenizer or a character tokenizer.

9. The method according to claim 1, further comprising utilizing, by the controller, a user interface for receiving the data string from a user.

10. The method according to claim 1, further comprising displaying the one or more arrangements for the data string on the user interface based on a ranking of the final probability.

11. A system for decomposition of a data string, the system comprising:
a memory configured to store the data string;
a controller configured to:
receive the data string as input data;
split the data string into a plurality of tokens;
perform an inter token modelling on plurality of tokens to obtain a first probability of arrangement of tokens with respect to each other, wherein the first probability is indicative of one or more structural forms of the plurality of tokens;
perform an intra token modelling on the plurality of tokens to obtain a second probability indicative of a number of occurrences of each individual token at in the arrangement of tokens of the plurality of tokens,
combine the first probability of the arrangement of tokens with the second probability of each individual token from of the plurality of tokens to obtain a final probability of arrangement for the data string; and
display one or more arrangements for the data string based on the final probability, wherein the one or more arrangements for the data string is indicative of structurally meaningful parts of decomposed data string.

12. The system according to claim 11, wherein, in order to perform the inter token modelling on plurality of tokens, the controller is further configured to apply a probabilistic context free grammar (PCFG) model on plurality of tokens.

13. The system according to claim 11, wherein, in order to perform the inter token modelling on plurality of tokens, the controller is further configured to apply a pre-trained probabilistic context free grammar (PCFG) model on plurality of tokens.

14. The system according to claim 11, wherein, in order to perform the inter token modelling on the plurality of tokens, the controller is further configured to:
parse the plurality of tokens for generating one or more structural forms,
obtain a probability of each structural form of the one or more structural forms, and
determine the first probability of the arrangement of tokens by combining probabilities of each structural form from the one or more structural forms.

15. The system according to claim 11, wherein, in order to perform the intra token modelling over the plurality of tokens, the controller is further configured to apply an N-gram model or unigram probabilities to obtain the second probability indicative of a number of occurrences of each individual token.

16. The system according to claim 11, wherein the data string is an unlabelled data string for un-supervised learning.

17. The system according to claim 11, wherein the controller is further configured to use machine learning models to obtain the first probability of arrangement of tokens with respect to each other and the second probability indicative of a number of occurrences of each individual token in the arrangement of tokens of the plurality of tokens.

18. The system according to claim 11, wherein the plurality of tokens are generated using a word tokenizer or a character tokenizer.

19. The system according to claim 11, wherein the controller is further configured to utilize a user interface to receive the data string from a user.

20. The system according to claim 11, wherein the controller is further configured to display the one or more orders of the arrangement of data string on the user interface based on a ranking of the final probability.
